(19) United States
(12) Patent Application Publication
(10) Pub. No.: US 2023/0042696 A1
(43) Pub. Date: Feb. 9, 2023

(54) PREDICTIVE RESOURCE PLANNING AND OPTIMIZATION

(71) Applicant: Aiperion LLC, Chicago, IL (US)

(72) Inventor: Sorina Ileana Zahan, Chicago, IL (US)

(21) Appl. No.: 17/394,833

(22) Filed: Aug. 5, 2021

(51) Int. Cl. G06Q 10/06; G06N 5/02

(52) U.S. Cl. CPC G06Q 10/0631; G06N 5/02

(57) ABSTRACT

Aspects described herein utilize a resource management model and a resource utilization model, such that simulations may be performed accordingly. For example, a resource management time period may be a timeframe during which resource management is simulated according to the resource management model, while a resource utilization time period may be the timeframe in which resource utilization is simulated. Optimizing a resource allocation based on such simulations may be computationally expensive, for example due to the number of simulation iterations associated with each optimization iteration. Accordingly, a simulation may utilize one or more gates, which may identify a simulation state that is indicative of a degraded optimization iteration. When such a sub-optimal iteration is identified, the simulation may be interrupted and a subsequent optimization iteration may be simulated instead. Thus, processing time may be reduced for iterations that are unlikely to ultimately result in an optimized resource allocation.

### BACKGROUND

Managing resources to prepare for future resource utilization may be difficult, especially in instances where resource utilization is variable and uncertain. Additionally, current or near-term resource management may affect resource availability in the future, which may similarly introduce difficulties, even in instances where resource utilization is static or otherwise predictable.

It is with respect to these and other general considerations that embodiments have been described. Also, although relatively specific problems have been discussed, it should be understood that the embodiments should not be limited to solving the specific problems identified in the background.

### SUMMARY

Rather than a set of rigid assumptions, aspects described herein utilize a resource management model and a resource utilization model, such that simulations may be performed accordingly. For example, a resource management time period may be a timeframe during which resource management is simulated according to the resource management model, while a resource utilization time period may be the timeframe in which resource utilization is simulated according to the resource utilization model.

Optimizing a resource allocation based on such simulations may be computationally expensive, for example due to the number of simulation iterations associated with each optimization iteration. Accordingly, a simulation may utilize one or more gates, which may identify a simulation state that is indicative of a degraded optimization iteration. When such a sub-optimal iteration is identified, the simulation may be interrupted and a subsequent optimization iteration may be simulated instead. Thus, processing time may be reduced for iterations that are unlikely to ultimately result in an optimized resource allocation.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for predictive resource planning and optimization.

FIG. 2 illustrates an overview of an example process flow for predictive resource planning and optimization.

FIG. 3 illustrates an overview of an example method for generating an optimized resource allocation according to aspects described herein.

FIG. 4 illustrates an overview of an example method for generating a simulation result according to aspects of the present disclosure.

FIG. 5 illustrates an example of a suitable operating environment in which one or more aspects of the present application may be implemented.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a set of resources may be managed for future resource utilization. For instance, future resource utilization may occur according to a predetermined schedule or in response to any of a variety of events, among other examples. However, the extent to which resources are utilized may be variable or may be unpredictable, thereby complicating management of the set of resources. Similarly, the availability of the set of resources at a given point in the future may be unpredictable, such that the set of resources itself may be variable and/or unpredictable. Thus, management of the set of resources in a way that is likely to satisfy future resource utilization is challenging given such variability and uncertainty.

Accordingly, aspects of the present application relate to predictive resource planning and optimization. In examples, resource management and resource utilization may each be modeled. Accordingly, a resource management model and a resource utilization model may be used to simulate future resource availability. As a result of such simulation, it may be possible to determine whether a given set of resources (e.g., managed according to the resource management model) satisfies anticipated resource utilization (e.g., according to the resource utilization model). Additionally, a resource allocation associated with the resource management model may be optimized in view of such a simulation, for example thereby increasing the likelihood that the set of resources is managed in a way that satisfies resource utilization in the future.

Thus, as compared to techniques where assumptions are made to address potential variability in resource management and resource utilization (e.g., according to a discount rate to discount future resource availability and/or utilization), aspects described herein reduce the potential impact of such assumptions on resource management optimization. Similarly, aspects of the present disclosure may further account for potential co-dependencies between resource management and resource utilization, which may otherwise be difficult or impossible to address in instances where more traditional assumption-based optimization is used. For instance, the management and optimization techniques described herein may be utilized without application of a discount rate in examples.

As used herein, a set of resources may be said to “match,” “meet,” or “satisfy” a resource utilization (e.g., at a given point in time) if sufficient resources are available. For example, resource utilization may consume or use resources, such that an amount of resources equal to or exceeding the resource utilization may be said to satisfy the resource utilization. Thus, once resources are utilized, at least a part of the resources may not be available for utilization in the future. In other examples, resources may be available for subsequent utilization after resource utilization at the given time period has passed or may gradually be replenished for subsequent utilization. Example resources include, but are not limited to, computing resources (e.g., processing time, available storage, or available memory), physical resources (e.g., goods or commodities), services, and/or monetary resources.

Further, given the variability among resource types, it will be appreciated that associated kinds of resource utilization may vary. As noted above, resource utilization may comprise consuming resources (e.g., as may be the case in instances where physical goods or monetary resources are consumed). In other instances, resources may be subsequently available after utilization has ended, as may be the case for computing resources. As another example, a resource may not be immediately available but may instead have a predetermined time period prior to availability, as may be the case with a crop of produce or a resource having a maturity or an availability date. In some instances, resource management may itself entail utilization of at least a part of the set of resources.

It will be appreciated that optimization as described herein need not result in optimal resource management, but may instead result in improved resource management as compared to a previous or un-optimized resource management model. Further, resource management may be optimized according to any of a variety of objectives, including, but not limited to, increasing the likelihood that resource utilization is satisfied (e.g., for a predetermined time period), managing resources so as to match resource utilization more closely, or fully depleting a set of resources after a predetermined amount of time. Further, the optimization aspects described herein may be performed with respect to a management time period and a resource utilization time period, which need not be the same or even overlapping. For example, a set of resources may be managed for the management time period, after which the resulting set of resources may be utilized for the utilization time period.

Resource management models and resource utilization models may each be any of a variety of models. Example models include, but are not limited to, stochastic models, deterministic models, machine learning models, or stepwise or non-linear models, among other mathematical models. A model may be generated based on historical data or based on a forecast or expectation associated with resource management and/or resource utilization. For example, historical resource behavior or performance may be used to generate a resource management model, as may be the case when historical resource performance is expected to be similar to future resource performance. As another example, a resource utilization model may be generated according to expected or estimated utilization associated with a set of resources (e.g., including a fixed resource utilization component and a variable resource utilization component).

Further, such aspects need not be restricted to a single model. In some instances, a set of models may be used to represent resource management and/or resource utilization. For example, a first model may be used for a first period of time, while a second model may be used for a second period of time. In instances where multiple models are used, there may be an association between a resource management model and a resource utilization model. For instance, a set of resource management models may have a corresponding set of resource utilization models. In other examples, a single resource management model may be used in combination with multiple resource utilization models, or vice versa.

Given resource management and/or resource utilization may be modeled as a set of models, aspects described herein may apply any of a variety of simulation techniques. For example, a set of resources resulting from a resource management model may be simulated in accordance with an associated management time period and, similarly, a resource utilization resulting from a resource utilization model may be simulated in accordance with an associated utilization time period. Example simulation techniques include, but are not limited to, a generalized autoregressive conditional heteroscedasticity (GARCH) simulation or a Monte Carlo simulation.

As noted above, resource management may be optimized according to any of a variety of objectives. For example, a set of weights associated with management of a set of resources may be optimized to yield an optimized resource allocation according to aspects described herein. Such optimization may be performed according to any of a variety of algorithms, including, but not limited to, genetic algorithms, simulated annealing, or other metaheuristic techniques.

Applying such metaheuristic techniques may comprise multiple optimization iterations, where each iteration evaluates a candidate resource allocation. For instance, a first iteration may evaluate a resource management model based on a first resource allocation, where it is determined whether the resulting first set of resources matches a resource utilization determined based on a resource utilization model. A second iteration may then evaluate the resource management model based on a potentially different resource allocation, thereby determining whether the resulting second set of resources matches (and/or is a better match for) a resource utilization determined based on the resource utilization model.

However, in instances where the set of resources and/or the resource utilization are determined according to the simulation techniques described herein, each optimization iteration may itself further comprise a number of simulation iterations, thereby yielding a large and potentially unwieldy total number of iterations (e.g., from the perspective of processor utilization, memory utilization, and/or any of a variety of other computing resources).

Accordingly, a simulation performed according to aspects described herein may comprise the application of one or more “gates.” In examples, a gate determines whether a simulation associated with a given optimization iteration should continue or whether the associated resource allocation is unlikely to yield an improvement. Thus, if the gate instead determines that the candidate resource allocation is unlikely to yield an improvement, the optimization may proceed to a subsequent iteration (e.g., for another candidate resource allocation) without completing the simulation associated with the current optimization iteration. In some instances, the gate may generate a simulation estimation as an alternative to the result that would have been obtained if the simulation were permitted to finish. In such instances, the simulation estimation may be used as part of the optimization, for example thereby enabling the optimization algorithm to determine how the candidate resource allocation performs as compared to prior candidates.

Applying a gate as used herein may comprise evaluating gating logic (e.g., a set of rules and/or instructions) or processing a state of the simulation according to a machine learning model. For instance, supervised learning or reinforcement learning may be used to process the state of the simulation to classify the simulation as an improvement (e.g., such that the simulation may be permitted to continue) or as a regression (e.g., such that the simulation may be terminated). Instances where the simulation appears to indicate the optimization iteration has not materially changed the result may similarly cause the simulation to terminate or, in other instances, may permit the simulation to continue.

A simulation may be permitted to continue even in instances where the machine learning model indicates that the simulation should be terminated, such that the determination of the machine learning model may be compared to the ultimate result of the simulation. Such instances may be used as training data with which to train the machine learning model (e.g., in addition to or as an alternative to human input, as may be the case where supervised learning is used). As noted above, the machine learning model may generate an estimate for the simulation in instances where the simulation is terminated. In other examples, a separate algorithm or model may additionally or alternatively be used to generate such a simulation estimation.

In instances where optimization is performed in view of multiple objectives, a gate may comprise application of multiple neural networks. For example, each objective may have an associated neural network with which to evaluate the simulation. In such instances, results from multiple neural networks may be processed according to any of a variety of techniques, for example by weighting the model results according to objective priority or a simulation may be terminated only when all or a majority of neural networks provide an indication to do so. For example, gating logic applied at a gate may process the output of one or more associated neural networks when determining whether to terminate or proceed with a simulation.

In other examples, different neural networks and/or gating logic may be applied at different gates as a simulation progresses. For example, a first neural network may be applied after a first number of iterations, while a second neural network may be applied after a second, greater number of iterations. The second neural network may be more selective, by virtue of the simulation being more mature as compared to when the first neural network was applied.

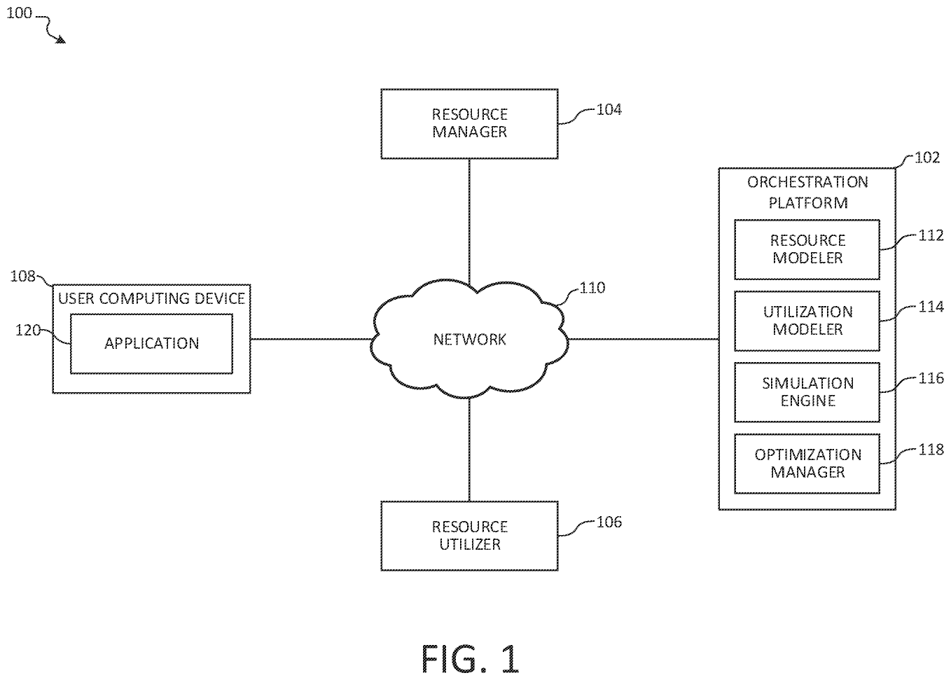

FIG. 1 illustrates an overview of an example system 100 for predictive resource planning and optimization. As illustrated, system 100 comprises orchestration platform 102, resource manager 104, resource utilizer 106, user computing device 108, and network 110. In examples, orchestration platform 102, resource manager 104, resource utilizer 106, and user computing device 108 communicate via network 110. For example, network 110 may comprise a local area network, a wireless network, or the Internet, or any combination thereof, among other examples.

Orchestration platform 102 comprises resource modeler 112, utilization modeler 114, simulation engine 116, and optimization manager 118. In examples, resource modeler 112 generates a resource management model associated with a set of resources, as may be managed by resource manager 104.

For example, resource manager 104 may allocate resources for utilization by resource utilizer 106 according to a resource allocation. The resource allocation may be an optimized resource allocation, as may be generated by orchestration platform 102 according to aspects described herein. As an example, resource manager 104 may be a tenant manger (e.g., managing computing resources for tenants of a virtualization platform), a network traffic manager (e.g., managing resources of a content distribution network), or an asset manager (e.g., managing a set of assets associated with one or more users or other entities). Thus, while resource manager 104 is illustrated as a single element of system 100, it will be appreciated that resource manager 104 may be integrated into any of a variety of other systems. Further, aspects of resource manager 104 described herein may be performed by any number of computing devices.

Resource utilizer 106 may utilize resources managed by resource manager 104. Similar to resource manager 104, resource utilizer may be integrated into any of a variety of other systems and/or aspects described herein with respect to resource utilizer 106 may be performed by any number of computing devices. For example, resource utilizer 106 may communicate with resource manager 104 via network 110 to utilize resources accordingly. As an example, resource utilizer 106 may be a computing device of a tenant utilizing virtualized resources of resource manager 104, a customer of a content distribution network associated with resource manager 104, or an individual or other entity for which assets are managed by resource manager 104.

Returning to resource modeler 112, historical data associated with resource manager 104 may be used to generate a resource management model. For example, the historical data may comprise historical resource performance, historical resource variance, historical replenishment information, historical growth information, and/or any of a variety of other information associated with resources of resource manager 104. Resource manager 104 may process the historical data to generate a mathematical model according to aspects described herein.

Similarly, utilization modeler 114 may generate a resource utilization model based on historical data associated with resource utilizer 106. Thus, in examples, the resource utilization model generated by utilization modeler 114 may be based at least in part on historical resource utilization of resources associated with resource manager 104. In other examples, utilization modeler 114 may receive an indication (e.g., from user computing device 108) of an estimate of a fixed and/or variable resource utilization component, which may be incorporated into a generated resource utilization model accordingly. Thus, a resource utilization model may be generated based on available data associated with resource utilization and/or received user input, among other examples.

While example model generation techniques are described with respect to resource modeler 112 and utilization modeler 114, it will be appreciated that any of a variety of additional or alternative techniques. For example, resource modeler 112 may similarly receive a user input from user computing device 108, which may be used in the model generation process. As an example, the received user input may comprise an indication as to a time period and/or a set of resources for which a model should be generated, among other examples.

Further, it will be appreciated that any number of resource managers and/or resource utilizers may be present in other examples. For example, orchestration platform 102 may generate a resource allocation that is used by a plurality of resource managers or, as another example, a plurality of resource utilizers may utilize resources of a single resource manager 104.

Orchestration platform 102 is further illustrated as comprising simulation engine 116. In examples, simulation engine 116 generates a simulation result for a given model, such as a resource management model generated by resource modeler 112 or a resource utilization model generated by utilization modeler 114. For example, a simulation performed by simulation engine 116 may be performed in any mathematical space and therefore need not be unidimensional. As an example, simulation engine 116 may perform a simulation in a combined space of the resource management and resource utilization models. It will be appreciated that such a multidimensional simulation may generate a unidimensional output or an output having fewer dimensions in some instances, for example by combining dimensions using one or more mathematical functions. Simulation engine 116 may apply any of a variety of simulation techniques, including, but not limited to, a GARCH simulation or a Monte Carlo simulation.

Optimization manager 118 may generate an optimized resource allocation according to aspects described herein. For example, optimization manager 118 may iteratively adapt a resource allocation, obtain a simulation result according to the adapted resource allocation (e.g., associated with a resource management model and/or a resource utilization model, as may be generated by simulation engine 116), and determine whether the adapted resource allocation is an improvement over a previously generated resource allocation. After performing a predetermined number of iterations and/or determining that a series of adapted resource allocations has converged, optimization manager 118 may provide the adapted resource allocation as an optimized resource allocation. The initial resource allocation used by optimization manager 118 may be determined randomly, according to received user input, or based on a previously generated optimized resource allocation, among other examples. It will be appreciated that such aspects are provided as an example optimization technique and, in other examples, a variety of other techniques may be used.

System 100 is further illustrated as comprising user computing device 108, which may be any of a variety of computing devices, including, but not limited to, a mobile computing device, a table computing device, a laptop computing device, or a desktop computing device. User computing device 108 is illustrated as comprising application 120. In examples, application 120 communicates with orchestration platform 102, for example to configure aspects of resource allocation optimization. As an example, application 120 may be a web browser used to access a website of orchestration platform 102. In another example, application 120 may communicate with orchestration platform 102 using an application programming interface (API).

Application 120 may receive user input associated with a resource management model and/or a resource utilization model, an indication of which may be provided to orchestration platform 102 to configure the behavior of resource modeler 112 and/or utilization modeler 114, respectively. As another example, application 120 may receive an indication of a resource management time period and/or a resource utilization time period, an indication of which may be provided to optimization manager 118 of orchestration platform 102 accordingly.

As a further example, orchestration platform 102 may provide an indication of a generated optimized resource allocation (e.g., to user computing device 108 and/or resource manager 104). In examples, the indication comprises at least a part of the optimized resource allocation. In some instances, the indication may comprise information associated with a simulation generated by simulation engine 116, such as a simulated set of resources (e.g., according to a resource management time period) and/or a simulated resource utilization (e.g., according to a resource utilization time period). For instance, a graphical representation of the set of resources over time as compared to resource utilization over time may be generated by orchestration platform 102 for display by application 120 of user computing device 108.

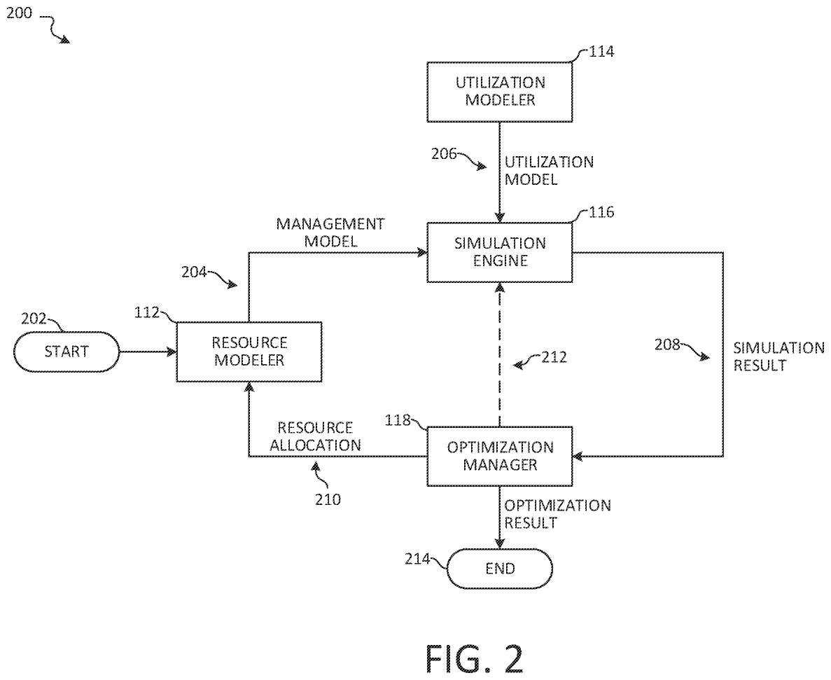

FIG. 2 illustrates an overview of an example process flow 200 for predictive resource planning and optimization. As illustrated, process flow 200 is between resource modeler 112, utilization modeler 114, simulation engine 116, and optimization manager 118, aspects of which were discussed above with respect to FIG. 1 and are therefore not necessarily re-described below in detail.

As illustrated, process flow 200 starts at operation 202 with resource modeler 112. As described above, resource modeler 112 generates a resource management model, which is provided to simulation engine 116 as illustrated by arrow 204. For example, resource modeler 112 may generate the resource management model according to historical data and/or a received indication of user input, among other examples.

Simulation engine 116 is further illustrated as receiving a resource utilization model from utilization modeler 114, as indicated by arrow 206. Accordingly, simulation engine 116 generates a simulation result according to the resource management model and the utilization model, which is provided to optimization manager 118 as illustrated by arrow 208.

In examples, the resource management model received from resource modeler 112 is processed by simulation engine 116 according to an initial resource allocation. Accordingly, optimization manager 118 may adapt the initial resource allocation according to any of a variety of algorithms, such that a subsequent iteration is performed using the adapted resource allocation, as illustrated by arrow 210. Thus, flow may loop among resource modeler 112, simulation engine 116, and optimization manager 118 to perform a series of optimization iterations.

Dashed arrow 212 is illustrated from optimization manager 118 to simulation engine 116 to indicate that, in examples, a simulation performed by simulation engine 116 as part of an optimization iteration may be gated as described above. Thus, in some instances, the simulation result provided to optimization manager 118 may be an estimated simulation result or may be an indication to progress to a subsequent optimization iteration. While optimization manager 118 is illustrated as performing the gating aspects with respect to the simulation performed by simulation engine 116, it will be appreciated that, in other examples, simulation engine 116 may additionally or alternatively perform at least some of such aspects.

Eventually, optimization manager 118 may determine to end optimization, such that an optimization result is generated and flow ends at operation 214. For example, optimization manager 118 may determine that a predetermined number of iterations have been performed or that candidate resource allocations have converged. While examples are described herein in which optimization manager 118 adapts a resources allocation associated with a resource management model from resource modeler 112, it will be appreciated that similar techniques may alternatively or additionally be applied to a resource utilization model from utilization modeler 114. For example, certain aspects of resource utilization may be managed (e.g., according to a management time period), such that optimization manager 118 may similarly optimize such aspects.

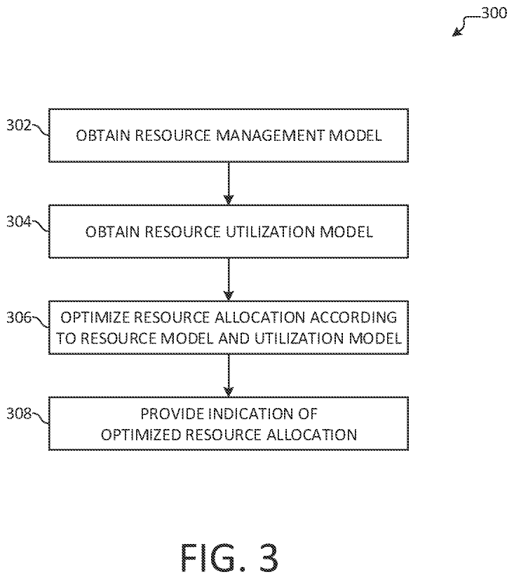

FIG. 3 illustrates an overview of an example method 300 for generating an optimized resource allocation according to aspects described herein. In examples, aspects of method 300 may be performed by an orchestration platform, such as orchestration platform 102 discussed above with respect to FIG. 1.

Method 300 begins at operation 302, where a resource management model is obtained. In examples, obtaining the resource management model comprises receiving or otherwise obtaining the resource management model from a resource modeler, such as resource modeler 112 discussed above with respect to FIG. 1. In other examples, operation 302 comprises receiving an indication of a resource management model, as may be received from an application of a user computing device, such as application 120 of user computing device 108. In some instances, operation 302 comprises generating a resource management model from historical data (e.g., associated with a resource manager, such as resource manager 104) and/or based on user input, among other examples.

Method 300 progresses to operation 304, where a resource utilization model is obtained. In examples, obtaining the resource utilization model comprises receiving or otherwise obtaining the resource utilization model from a utilization modeler, such as utilization modeler 114 discussed above with respect to FIG. 1. In other examples, operation 304 comprises receiving an indication of a resource utilization model, as may be received from an application of a user computing device, such as application 120 of user computing device 108. In some instances, operation 304 comprises generating a resource utilization model from historical data (e.g., associated with a resource utilizer, such as resource utilizer 106) and/or based on user input, among other examples.

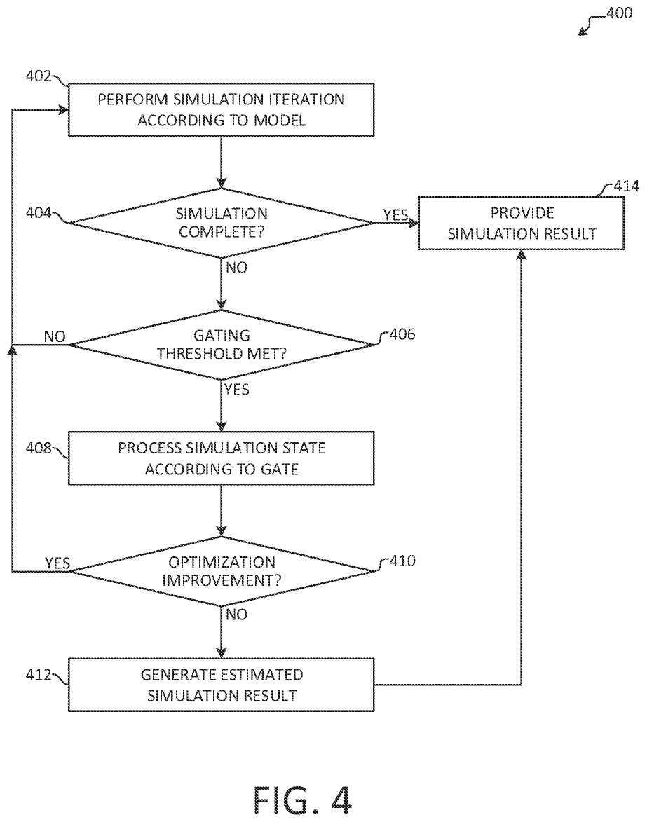

At operation 306, an optimized resource allocation is generated according to the resource management model and the resource utilization model. In examples, aspects of operation 306 are similar to those of flow 200 discussed above with respect to FIG. 2. For example, operation 306 may comprise iteratively generating simulation results based on the resource management model and the resource utilization model, where a candidate resource allocation is adapted at each iteration. In some instances, operation 306 may comprise determining to terminate a simulation according to one or more gates, such that the optimization progresses to a subsequent candidate accordingly. Additional examples of such aspects are discussed below with respect to method 400 in FIG. 4.

Eventually, it may be determined that the resource allocation is optimized, for example as a result of performing a predetermined number of iterations or based on determining that candidate resource allocations have converged. Accordingly, flow continues to operation 308, where an indication of the optimized resource allocation is provided. In examples, the indication is provided to a resource manager, such as resource manager 104 discussed above with respect to FIG. 1. As another example, the indication may be provided to an application of a user computing device, such as application 120 of user computing device 108. For example, the indication may comprise at least a part of the optimized resource allocation and/or simulation information associated with the optimized resource allocation (e.g., as may be provided for display by the application). Method 300 terminates at operation 308.

FIG. 4 illustrates an overview of an example method 400 for generating a simulation result according to aspects of the present disclosure. In examples, aspects of method 400 are performed by an orchestration platform, such as orchestration platform 102 discussed above with respect to FIG. 1. For example, aspects of method 400 may be performed by a simulation engine and/or an optimization manager, such as simulation engine 116 and optimization manager 118, respectively. As another example, aspects of method 400 may be performed as part of operation 306 discussed above with respect to method 300 in FIG. 3.

Method 400 begins at operation 402, where a simulation iteration is performed according to a model. For example, operation 402 may comprise performing a simulation iteration as part of a GARCH or Monte Carlo simulation, among other simulation techniques. Operation 402 may be performed using a resource management model and/or a resource utilization model, as may have been generated by a resource modeler (e.g., resource modeler 112) or a utilization modeler (e.g., utilization modeler 114), respectively.

Flow progresses to determination 404, where it is determined whether the simulation is complete. For example, determination 404 may comprise determining whether a predetermined number of iterations has been performed or determining that the simulation has converged, among other examples. Accordingly, if it is determined that the simulation is complete, flow branches “YES” to operation 414, where a simulation result is provided. For example, the simulation result may be provided to an optimization manager, such that the optimization manager may determine whether the simulation result (e.g., as may be associated with a candidate resource allocation) is an improvement over a previously generated simulation result (e.g., associated with a previous candidate resource allocation) as described above. Method 400 terminates at operation 414.

If, however, it is instead determined that the simulation is not complete, flow branches “NO” to determination 406, where it is determined whether a gating threshold has been met. For example, a gating threshold may be identified after a predetermined number of iterations. As another example, a dynamic gating threshold may be used (e.g., rather than a predetermined number of iterations). For instance, a dynamic gating threshold may be based at least in part on how many optimization iterations have been performed. As discussed above, multiple gates may be used, such that determination 406 may conclude that a gating threshold has been met at various iterations of method 400. If it is determined that a gating threshold has not been met, flow branches “NO” and returns to operation 402, where another simulation iteration is performed.

If, however, it is determined that a gating threshold has been met, flow instead branches “YES” to operation 408, where the simulation state is processed according to an associated gate. For example, operation 408 may comprise processing gating logic or using a machine learning model to characterize the simulation state (e.g., as exhibiting an optimization improvement, as being indeterminate, or as exhibiting an optimization degradation). In some instances, operation 408 comprises selecting a machine learning model from a set of machine learning models, as different machine learning models may be applied to different iterations as method 400 progresses.

Flow moves to determination 410, where it is determined whether the simulation state is indicative of an optimization improvement. For example, determination 410 may comprise evaluating a result of gating logic that was executed at operation 408 or may comprise evaluating a classification that was generated by a machine learning model that was applied at operation 408, among other examples. Accordingly, if it is determined that the simulation state is indicative of an optimization improvement (or, as another example, is not indicative of an optimization degradation), flow branches “YES” and returns to operation 402, where another simulation iteration is performed as discussed above.

However, if it is determined that the simulation state is not indicative of an optimization improvement (or, as another example, is indicative of an optimization degradation), flow instead branches “NO” to operation 412, where an estimated simulation result is generated. In examples, the estimated simulation result is based at least in part on processing that was performed at operation 408. For example, the gating logic or machine learning model may generate an estimated simulation result that may be used at operation 412. As another example, an estimation model (e.g., that is distinct from a model applied at operation 408) may be used at operation 412 to generate the estimated simulation result accordingly.

Flow progresses to operation 414, where the estimated simulation result is provided as the simulation result. For example, the estimated simulation result may be provided to an optimization manager (e.g., optimization manager 118 of orchestration platform 102 in FIG. 1) as described above. Method 400 terminates at operation 414.

It will be appreciated that method 400 is described in an example where an estimated simulation result is generated. In other examples, an indication may be provided that it was determined that the simulation is indicative of an optimization degradation rather than providing an estimation result. In another example, method 400 may continue iterating even if it is determined that the simulation state is not indicative of an optimization improvement, as may be the case when reinforcement learning techniques are used as described above. Further, while example gating aspects are described with respect to operations 406-410, it will be appreciated that any of a variety of additional or alternative thresholds, processing, and/or determinations may be used. For example, multiple instances of gating logic or multiple machine learning models may be applied at operation 408, as may be the case when an optimization is performed with respect to multiple optimization objectives.

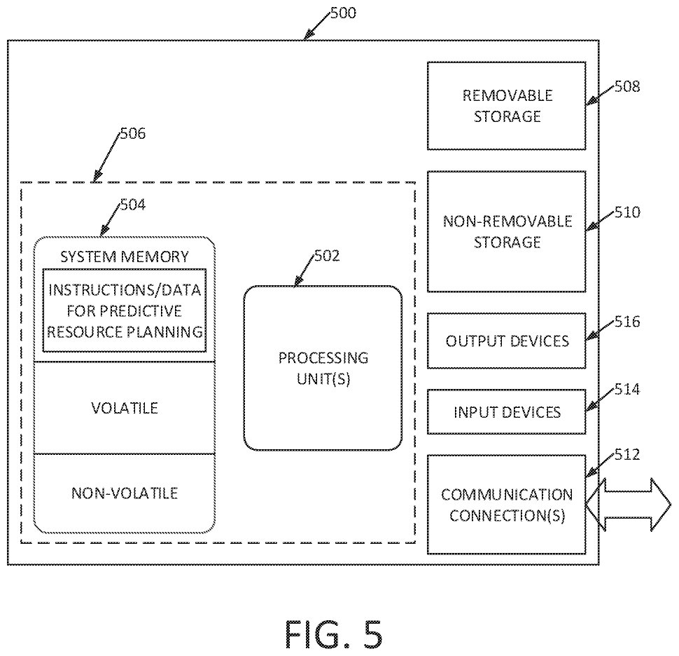

FIG. 5 illustrates an example of a suitable operating environment 500 in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 500 typically may include at least one processing unit 502 and memory 504. Depending on the exact configuration and type of computing device, memory 504 (storing, among other things, APIs, programs, etc. and/or other components or instructions to implement or perform the system and methods disclosed herein, etc.) may be volatile (such as RAM), non-volatile (such as ROM, flash memory, etc.), or some combination of the two. This most basic configuration is illustrated in FIG. 5 by dashed line 506. Further, environment 500 may also include storage devices (removable, 508, and/or non-removable, 510) including, but not limited to, magnetic or optical disks or tape. Similarly, environment 500 may also have input device(s) 514 such as a keyboard, mouse, pen, voice input, etc. and/or output device(s) 516 such as a display, speakers, printer, etc. Also included in the environment may be one or more communication connections, 512, such as LAN, WAN, point to point, etc.

Operating environment 500 may include at least some form of computer readable media. The computer readable media may be any available media that can be accessed by processing unit 502 or other devices comprising the operating environment. For example, the computer readable media may include computer storage media and communication media. The computer storage media may include volatile and nonvolatile, removable and non-removable media implemented in any method or technology for storage of information such as computer readable instructions, data structures, program modules or other data. The computer storage media may include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium, which can be used to store the desired information. The computer storage media may not include communication media.

The communication media may embody computer readable instructions, data structures, program modules, or other data in a modulated data signal such as a carrier wave or other transport mechanism and includes any information delivery media. The term “modulated data signal” may mean a signal that has one or more of its characteristics set or changed in such a manner as to encode information in the signal. For example, the communication media may include a wired media such as a wired network or direct-wired connection, and wireless media such as acoustic, RF, infrared and other wireless media. Combinations of the any of the above should also be included within the scope of computer readable media.

The operating environment 500 may be a single computer operating in a networked environment using logical connections to one or more remote computers. The remote computer may be a personal computer, a server, a router, a network PC, a peer device or other common network node, and typically includes many or all of the elements described above as well as others not so mentioned. The logical connections may include any method supported by available communications media. Such networking environments are commonplace in offices, enterprise-wide computer networks, intranets and the Internet.

The different aspects described herein may be employed using software, hardware, or a combination of software and hardware to implement and perform the systems and methods disclosed herein. Although specific devices have been recited throughout the disclosure as performing specific functions, one skilled in the art will appreciate that these devices are provided for illustrative purposes, and other devices may be employed to perform the functionality disclosed herein without departing from the scope of the disclosure.

As stated above, a number of program modules and data files may be stored in the system memory 504. While executing on the processing unit 502, program modules (e.g., applications, Input/Output (I/O) management, and other utilities) may perform processes including, but not limited to, one or more of the stages of the operational methods described herein such as the methods illustrated in FIG. 2, 3, or 4, for example.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the operating environment 500 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

As will be understood from the foregoing disclosure, one aspect of the technology relates to a system comprising: at least one processor; and memory storing instructions that, when executed by the at least one processor, causes the system to perform a set of operations. The set of operations comprises: obtaining a resource management model associated with a set of resources of a resource manager; obtaining a resource utilization model associated with future utilization of the set of resources; generating, based on the resource management model and the resource utilization model, a resource allocation; and providing an indication of the resource allocation for management of the set of resources. In an example, generating the resource allocation comprises performing a series of optimization iterations; and each optimization iteration of the series of optimization iterations has an associated candidate resource allocation. In another example, generating the resource allocation further comprises, for each optimization iteration, generating a simulation result based on the associated candidate resource allocation. In a further example, generating the simulation result comprises: evaluating a state of a simulation according to a gate to determine whether to terminate the simulation; and based on determining to terminate the simulation, generating an estimated simulation result as the simulation result. In yet another example, generating the resource allocation comprises generating an optimized resource allocation having an increased likelihood that the set of resources will match the future utilization of the set of resources. In a further still example, the resource management model is associated with a resource management time period; and the resource utilization model is associated with a resource utilization time period. In another example, the resource management model is associated with historical data for the set of resources; and the resource utilization model is associated with an estimate of the future utilization of the set of resources.

In another aspect, the technology relates to a method for processing a model associated with an optimization. The method comprises: generating, based on the model using a candidate resource allocation associated with the optimization, a simulation iteration of a simulation; determining whether the simulation iteration meets a gating threshold; and based on determining that the simulation iteration meets the gating threshold: processing the simulation iteration to determine whether to terminate the simulation; and based on determining to terminate the simulation: generating an estimated simulation result; and providing the estimated simulation result as a simulation result of the simulation for the candidate resource allocation. In an example, the candidate resource allocation is a first candidate resource allocation; the simulation iteration is a firsts simulation iteration; the simulation is a first simulation; and the method further comprises: generating, based on the model using a second candidate resource allocation associated with the optimization, a second simulation iteration of a second simulation; determining whether the second simulation iteration meets the gating threshold; and based on determining that the second simulation iteration meets the gating threshold: processing the second simulation iteration to determine whether to terminate the simulation; determining not to terminate the simulation; and providing a simulation result for the second simulation associated with the second candidate resource allocation. In another example, the second candidate resource allocation is an improved resource allocation compared to the first candidate resource allocation. In a further example, processing the simulation iteration to determine whether to terminate the simulation comprises processing the simulation iteration according to a machine learning model to classify the simulation iteration. In yet another example, the estimated simulation result is generated using an estimation model that is distinct from the machine learning model. In a further still example, the gating threshold is a dynamic gating threshold.

In a further aspect, the technology relates to a method for generating a simulation according to a resource management model and a resource utilization model. The method comprises: obtaining the resource management model, wherein the resource management model is associated with a set of resources of a resource manager; obtaining the resource utilization model, wherein the resource utilization model associated with future utilization of the set of resources; generating, based on the resource management model and the resource utilization model, at least one of a resource allocation or a resource utilization; and providing an indication of the resource allocation or the resource utilization for management of the set of resources. In an example, generating the resource allocation or the resource utilization comprises performing a series of optimization iterations; and each optimization iteration of the series of optimization iterations has an associated optimization candidate. In another example, the generating further comprises, for each optimization iteration, generating a simulation result based on the associated optimization candidate. In a further example, generating the simulation result comprises: evaluating a state of a simulation according to a gate to determine whether to terminate the simulation; and based on determining to terminate the simulation, generating an estimated simulation result as the simulation result. In yet another example, generating the resource allocation comprises generating an optimized resource allocation having an increased likelihood that the set of resources will match the future utilization of the set of resources. In a further still example, the resource management model is associated with a resource management time period; and the resource utilization model is associated with a resource utilization time period. In an example, the resource management model is associated with historical data for the set of resources; and the resource utilization model is associated with an estimate of the future utilization of the set of resources.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, causes the system to perform a set of operations, the set of operations comprising:
obtaining a resource management model associated with a set of resources of a resource manager;
obtaining a resource utilization model associated with future utilization of the set of resources;
generating, based on the resource management model and the resource utilization model, a resource allocation; and
providing an indication of the resource allocation for management of the set of resources.

2. The system of claim 1, wherein:
generating the resource allocation comprises performing a series of optimization iterations; and
each optimization iteration of the series of optimization iterations has an associated candidate resource allocation.

3. The system of claim 2, wherein generating the resource allocation further comprises, for each optimization iteration, generating a simulation result based on the associated candidate resource allocation.

4. The system of claim 3, wherein generating the simulation result comprises:
evaluating a state of a simulation according to a gate to determine whether to terminate the simulation; and
based on determining to terminate the simulation, generating an estimated simulation result as the simulation result.

5. The system of claim 1, wherein generating the resource allocation comprises generating an optimized resource allocation having an increased likelihood that the set of resources will match the future utilization of the set of resources.

6. The system of claim 1, wherein:
the resource management model is associated with a resource management time period; and
the resource utilization model is associated with a resource utilization time period.

7. The system of claim 1, wherein:
the resource management model is associated with historical data for the set of resources; and
the resource utilization model is associated with an estimate of the future utilization of the set of resources.

8. A method for processing a model associated with an optimization, comprising:
generating, based on the model using a candidate resource allocation associated with the optimization, a simulation iteration of a simulation;
determining whether the simulation iteration meets a gating threshold; and
based on determining that the simulation iteration meets the gating threshold:
processing the simulation iteration to determine whether to terminate the simulation; and
based on determining to terminate the simulation:
generating an estimated simulation result; and
providing the estimated simulation result as a simulation result of the simulation for the candidate resource allocation.

9. The method of claim 8, wherein:
the candidate resource allocation is a first candidate resource allocation;
the simulation iteration is a firsts simulation iteration;
the simulation is a first simulation; and
the method further comprises:
generating, based on the model using a second candidate resource allocation associated with the optimization, a second simulation iteration of a second simulation;
determining whether the second simulation iteration meets the gating threshold; and
based on determining that the second simulation iteration meets the gating threshold:
processing the second simulation iteration to determine whether to terminate the simulation;
determining not to terminate the simulation; and
providing a simulation result for the second simulation associated with the second candidate resource allocation.

10. The method of claim 9, wherein the second candidate resource allocation is an improved resource allocation compared to the first candidate resource allocation.

11. The method of claim 8, wherein processing the simulation iteration to determine whether to terminate the simulation comprises processing the simulation iteration according to a machine learning model to classify the simulation iteration.

12. The method of claim 11, wherein the estimated simulation result is generated using an estimation model that is distinct from the machine learning model.

13. The method of claim 8, wherein the gating threshold is a dynamic gating threshold.

14. A method for generating a simulation according to a resource management model and a resource utilization model, comprising:
obtaining the resource management model, wherein the resource management model is associated with a set of resources of a resource manager;
obtaining the resource utilization model, wherein the resource utilization model associated with future utilization of the set of resources;
generating, based on the resource management model and the resource utilization model, at least one of a resource allocation or a resource utilization; and
providing an indication of the resource allocation or the resource utilization for management of the set of resources.

15. The method of claim 14, wherein:
generating the resource allocation or the resource utilization comprises performing a series of optimization iterations; and
each optimization iteration of the series of optimization iterations has an associated optimization candidate.

16. The method of claim 15, wherein the generating further comprises, for each optimization iteration, generating a simulation result based on the associated optimization candidate.

17. The method of claim 16, wherein generating the simulation result comprises:
evaluating a state of a simulation according to a gate to determine whether to terminate the simulation; and
based on determining to terminate the simulation, generating an estimated simulation result as the simulation result.

18. The method of claim 14, wherein generating the resource allocation comprises generating an optimized resource allocation having an increased likelihood that the set of resources will match the future utilization of the set of resources.

19. The method of claim 14, wherein:
the resource management model is associated with a resource management time period; and
the resource utilization model is associated with a resource utilization time period.

20. The method of claim 14, wherein:
the resource management model is associated with historical data for the set of resources; and
the resource utilization model is associated with an estimate of the future utilization of the set of resources.
